(19) United States
(12) Patent Application Publication
(10) Pub. No.: US 2026/0230353 A1
(43) Pub. Date: Aug. 6, 2026

(54) RECEIVER AND ITS OPERATING METHOD

(71) Applicant: KOREA UNIVERSITY RESEARCH AND BUSINESS FOUNDATION, Seoul (KR)

(72) Inventors: Chulwoo KIM, Seoul (KR); TaeHwan Kim, Seoul (KR); Seung-Woo Park, Seoul (KR)

(21) Appl. No.: 19/299,189

(22) Filed: Aug. 13, 2025

(30) Foreign Application Priority Data
Feb. 4, 2025 (KR) 10-2025-0014040

(51) Int. Cl. H04L 25/03; H04B 1/18; H04L 25/49

(52) U.S. Cl. CPC H04L 25/03267; H04B 1/18; H04L 25/49

(57) ABSTRACT

Disclosed is a receiver, which includes a CDR (clock and data recovery) module that recovers a clock and data from a PAM (pulse amplitude modulation)-3 signal received through a communication channel based on a first coefficient for equalizing and recovering the data and a second coefficient for equalizing and recovering the clock, and an adaptation module that controls the first coefficient and the second coefficient.

### CROSS-REFERENCE TO RELATED APPLICATIONS

This application claims priority under 35 U.S.C. § 119 to Korean Patent Application No. 10-2025-0014040 filed on Feb. 4, 2025, in the Korean Intellectual Property Office, the disclosures of which are incorporated by reference herein in their entireties.

### BACKGROUND

Embodiments of the present disclosure described herein relate to a receiver for solving a locking point issue that occurs during clock and data recovery of a PAM (pulse amplitude modulation)-3 signal.

With the development of high-speed data transmission technology, multilevel modulation methods such as a PAM-3 are widely adopted to increase data transmission efficiency. The PAM-3 method increases the data transmission speed by using three voltage levels per one symbol, and is utilized in various applications such as high-speed communication networks and storage device interfaces.

However, in the process of recovering clocks and data based on PAM-3 signals, data errors may occur due to incorrect clock locking. In addition, various signal distortion factors such as jitter, noise, and inter-symbol interference (ISI) occurring in high-speed data transmission channels may reduce the accuracy of the data restoration process.

Up to now, various methods are being proposed and studied to compensate for the ISI of the PAM-3 signals and solve locking point issues..

### SUMMARY

Embodiments of the present disclosure provide to solve the problem of data error occurrence during clock and data recovery and the problem of clock phase locking.

According to an embodiment of the present disclosure, a receiver includes a CDR (clock and data recovery) module that recovers a clock and data from a PAM (pulse amplitude modulation)-3 signal received through a communication channel based on a first coefficient for equalizing and recovering the data and a second coefficient for equalizing and recovering the clock, and an adaptation module that controls the first coefficient and the second coefficient.

According to an embodiment of the present disclosure, a method of operating a receiver for recovering a clock and data, in a process of sampling a PAM-3 signal received through a communication channel, includes matching sizes of a pre-cursor and a post-cursor, obtaining a size of a main cursor; obtaining a first coefficient for data recovery, increasing and decreasing a second coefficient by dividing conditions into comparing the size of the obtained main cursor with a size of a next order main cursor and comparing the first coefficient with a next order first coefficient, and returning to the obtaining the size of the main cursor, to iterate the operations in order.

### BRIEF DESCRIPTION OF THE FIGURES

The above and other objects and features of the present disclosure will become apparent by describing in detail embodiments thereof with reference to the accompanying drawings.

FIG. 1 is a block diagram of a receiver, according to an embodiment of the present disclosure.

FIG. 2 is a diagram associated with a PAM-3 signal sampling method.

FIG. 3A is a diagram for describing an effect of a decision feedback equalizer of a CDR module.

FIG. 3B is a diagram for describing an effect of a decision feedback equalizer in a CDR module on phase lock.

FIG. 4 is a diagram for describing a CDR module, according to an embodiment of the present disclosure.

FIG. 5A is a diagram illustrating a decision feedback equalizer structure, according to an embodiment of the present disclosure.

FIG. 5B is a diagram illustrating an operation of a receiver, according to an embodiment of the present disclosure.

FIG. 5C is a diagram illustrating a PAM-3 signal sampling point, according to an embodiment of the present disclosure.

FIG. 6 is a flowchart illustrating an operation method of a receiver, according to an embodiment of the present disclosure.

FIG. 7A is a flowchart illustrating a method for determining a decision feedback equalizer tap coefficient, according to an embodiment of the present disclosure.

FIG. 7B is a diagram of an SBR illustrating a process of FIG. 7A.

FIG. 8A and FIG. 8B is a diagram illustrating a change in a lock point of a CDR according to a tap coefficient for clock recovery, respectively.

FIG. 9 is a diagram illustrating an adder and a sampler, according to an embodiment of the present disclosure.

### DETAILED DESCRIPTION

Hereinafter, embodiments of the present disclosure will be described clearly and in detail with reference to the attached drawings.

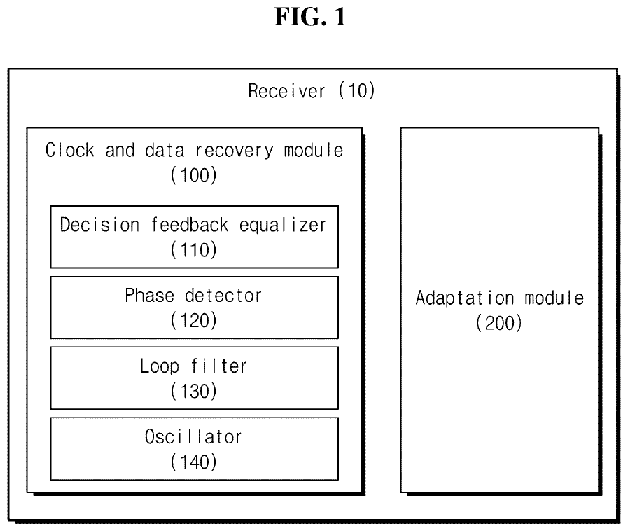

FIG. 1 is a block diagram of a receiver, according to an embodiment of the present disclosure.

Referring to FIG. 1, a receiver 10 according to an embodiment of the present disclosure may include a clock and data recovery (CDR) module 100 for reducing errors in receiving a PAM-3 signal and an adaptation module 200 connected to the clock and data recovery module 100 to control clock recovery.

The clock and data recovery module 100 according to an embodiment of the present disclosure may include a decision feedback equalizer 110, a phase detector 120, a loop filter 130, and an oscillator 140.

The decision feedback equalizer 110 may perform equalization based on a first coefficient for equalizing and recovering data and a second coefficient for equalizing and recovering a clock.

The phase detector 120 may perform phase detection based on an equalizing signal corresponding to the equalization.

The loop filter 130 may lock a phase of the clock based on a detection signal corresponding to the phase detection.

The oscillator 140 may output a clock having a phase corresponding to the locking.

In addition, according to an embodiment, a decoder may be further included that decodes and outputs a signal in which the clock and data are recovered in the clock and data recovery module.

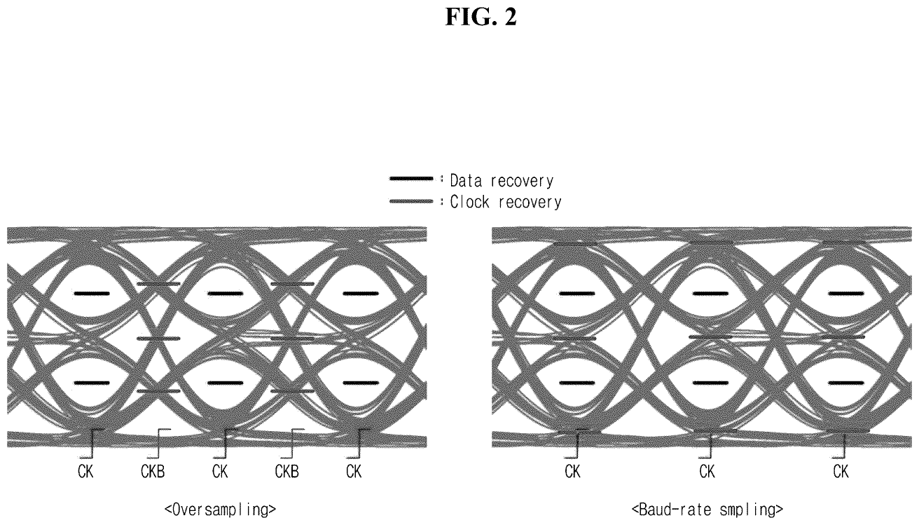

FIG. 2 is a diagram associated with a PAM-3 signal sampling method.

A sampling method of the receiver for clock and data recovery may be divided into oversampling and baud-rate sampling, and the present disclosure uses the baud-rate sampling method.

In the oversampling method, when data and clock information are obtained from different clock phases, at least two clock phases are required, so a circuit for generating an additional clock phase is required. Therefore, the addition of a circuit for generating a clock phase has the disadvantage of increasing power consumption.

Since the baud-rate sampling method obtains data and clock information from the same clock, an additional clock phase generation circuit is not required, so power consumption may be reduced. However, compared to the oversampling method, there is a disadvantage that the performance of clock and data recovery is lowered since less clock information may be obtained.

The clock and data recovery module illustrated in the above-described FIG. 1 may operate based on the baud-rate sampling method.

A typical clock and data recovery module uses one clock for sampling and recovering clock and data using the baud-rate sampling method, so power consumption is low, but the performance of clock and data recovery may be lower.

In contrast, the clock and data recovery module according to the present disclosure uses the baud-rate sampling method, but performs equalization based on a first coefficient for equalizing and recovering the data and a second coefficient for equalizing and recovering the clock, thereby improving the performance of clock and data recovery.

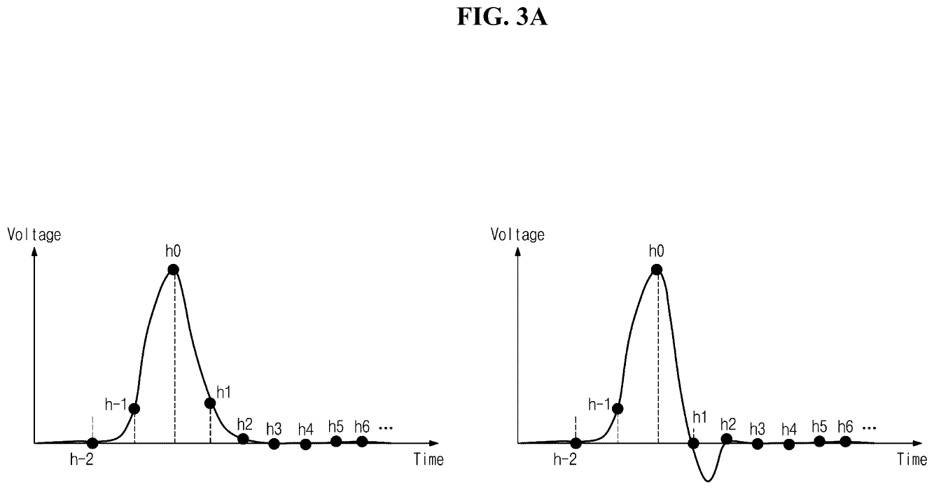

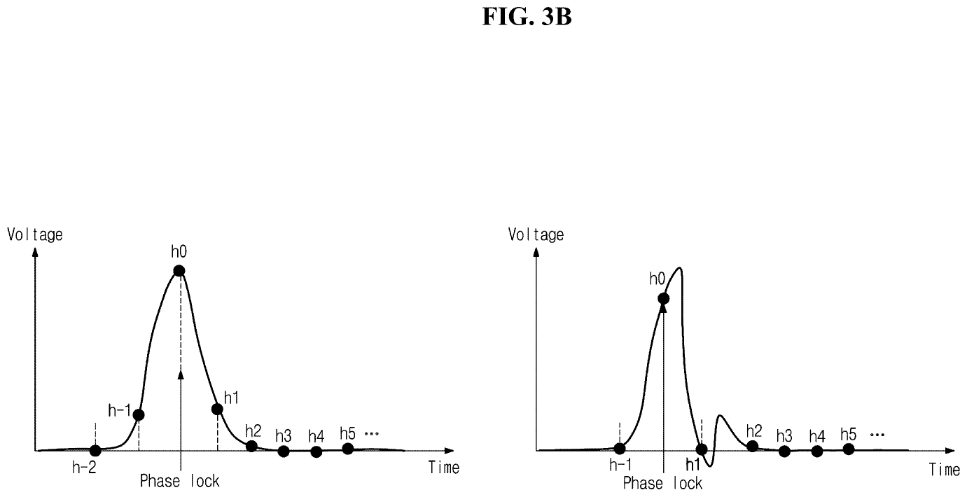

FIG. 3A is a diagram for describing an effect of a decision feedback equalizer of a CDR module.

An SBR (single bit response), which is a method of checking the output by passing only one bit through the channel, may determine the characteristics of the channel and the effect of the equalizer.

When the highest point of the SBR output is defined as a main cursor h₀, the point that is 1 UI (unit interval) away before h₀ may be defined as a pre-cursor h₋₁, h₋₂, . . . , and the point that is 1 UI away after h₀ may be defined as a post-cursor h₁, h₂, . . . .

In this case, the decision feedback equalizer 110 may remove the post-cursor generated from data passing through a channel with limited bandwidth to improve the stability of data reception.

Referring to FIG. 3A, the left side is a diagram before applying the decision feedback equalizer, and the right side is a diagram after applying the decision feedback equalizer. In the decision feedback equalizer, the post-cursor is removed depending on the number of taps. For example, when there is one tap, h₁ may be removed.

As will be described in detail later, the CDR module according to one embodiment of the present disclosure performs data equalization and recovery through the decision feedback equalizer, thereby eliminating a post cursor and thereby improving the stability of data reception.

FIG. 3B is a diagram for describing an effect of a decision feedback equalizer in a CDR module on phase lock.

The CDR module adjusts the clock phase in real time such that the first pre-cursor h₋₁ and the first post-cursor h₁ become the same. As described in the left diagram of FIG. 3B, in order for the clock phase to be locked at the highest point h₀ in the SBR, h₋₁ and h₁ should have a specific value other than “0”.

However, when h₋₁ and h₁ are not removed, the ISI (inter symbol interference) may occur, which may cause an error when receiving data. Therefore, h₁ needs to be removed as described in the right diagram of FIG. 3B.

In a situation of the right diagram, the first pre-cursor h₋₁ and the first post-cursor h₁ become the same again during the clock and data recovery process, and in this case, h₀ is deflected to the left of the ideal point, which is the maximum value point.

The height of the deflected h₀ becomes lower than the original h₀, and the situation where h₀ is deflected may cause an error to increase when receiving data. In addition, since the point where h₋₁=0 becomes ambiguous, a large amount of jitter occurs in the recovered clock.

Therefore, when a decision feedback equalizer is used in the clock and data recovery process when receiving the PAM-3 signal, a problem occurs in which an error increases when receiving data or a jitter increases in the clock.

As will be described later, referring to the receiver of FIG. 1, since the adaptation module 200 according to an embodiment of the present disclosure may control the coefficients for clock equalization and recovery, the first pre-cursor h₋₁ and the first post-cursor h₁ may be made the same in the clock equalization and recovery process. When the first pre-cursor h₋₁ and the first post-cursor h₁ become the same, the problem in which jitter occurs may be solved since h₀ approaches the maximum point.

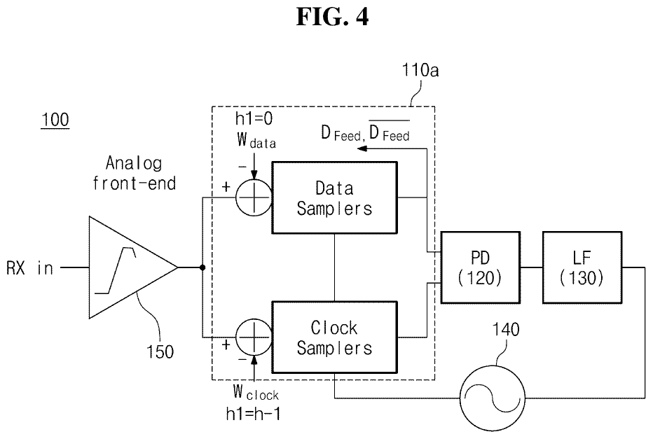

FIG. 4 is a diagram for describing a CDR module, according to an embodiment of the present disclosure.

Referring to FIG. 4, a CDR module according to an embodiment of the present disclosure may include a decision feedback equalizer 110a, the phase detector 120, the loop filter 130, and the oscillator 140. In addition, it may be confirmed that the path of the tap for clock recovery and the path of the tap for data recovery in the decision feedback equalizer 110a are independent.

As briefly described above, the decision feedback equalizer 110a may perform equalization on the PAM-3 signal based on a first coefficient and a second coefficient. As some embodiments, the decision feedback equalizer 110a may include a first path for data equalization and recovery and a second path for clock equalization and recovery.

The first path may operate based on the first coefficient. In detail, the first path may include a first adder and a data sampler. The first adder may receive the first coefficient as a feedback and may add the first coefficient to the PAM-3 signal. The equalized data signal according to the addition may be transmitted to the data sampler. In this process, data equalization and recovery are performed.

The loop filter 130 finds a locking phase where h₁=h₋₁ may be, and the oscillator transmits a clock having the locked phase to the clock sampler.

Thereafter, as in the above description, the second path may operate based on the second coefficient. In detail, the second path may include a second adder and a clock sampler. The second adder may receive the second coefficient as a feedback and may add the second coefficient to the PAM-3 signal. The equalized clock signal according to the addition may be transmitted to the clock sampler. In this process, clock equalization and recovery are performed.

As some embodiments, an analog front end 150 coupled to the input terminal of the decision feedback equalizer 110a may be further included. The analog front end 150 is a component that allows the PAM-3 signal to be input and processed on a digital domain.

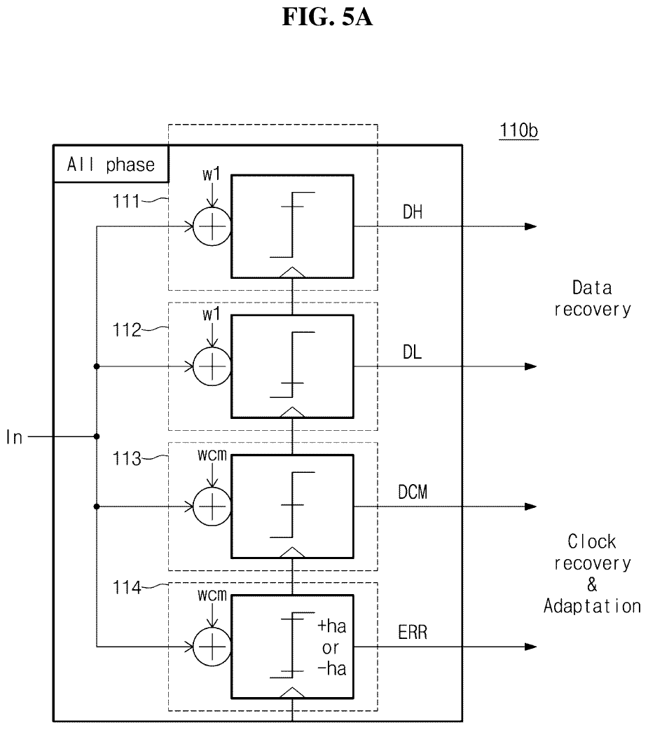

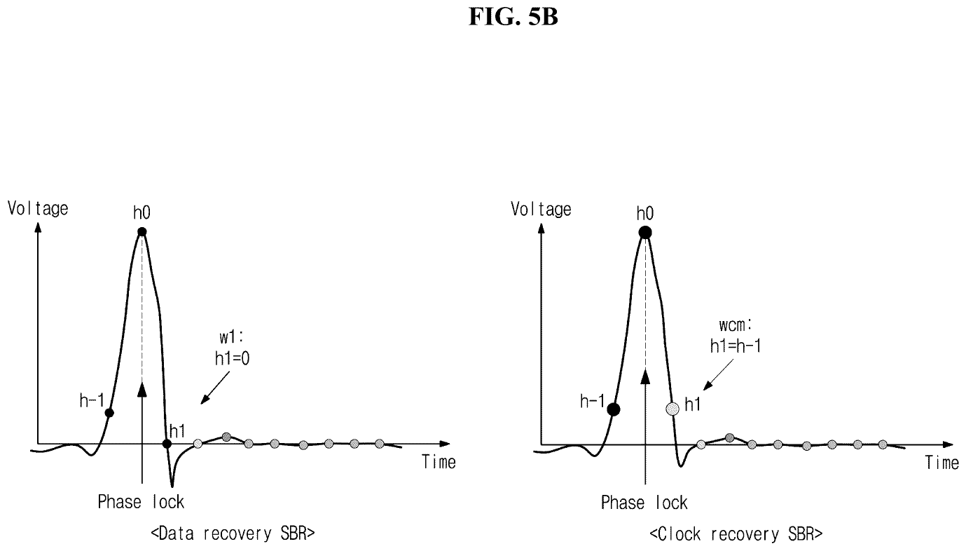

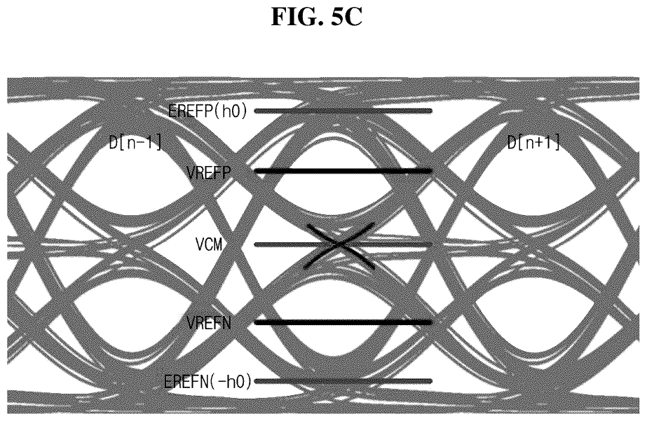

FIG. 5A is a diagram illustrating a decision feedback equalizer structure, according to an embodiment of the present disclosure.

Referring to FIG. 5A, the decision feedback equalizer according to an embodiment of the present disclosure may make the SBR independent by making the decision feedback equalizer tap coefficients different in order to make the data recovery SBR and the clock recovery SBR different.

A first adder and sampler 111 and a second adder and sampler 112 perform equalization on a PAM-3 signal “In” based on a first coefficient “w1”. According to the equalization, equalized data signals DH and DL may be output.

A third adder and sampler 113 and a fourth adder and sampler 114 perform equalization on the PAM-3 signal “In” based on a second coefficient wcm. According to the equalization, equalized data signals DCM and ERR may be output. In this case, the second coefficient wcm may be the second coefficient wclock of FIG. 4.

FIG. 5B is a diagram illustrating an operation of a receiver, according to an embodiment of the present disclosure.

A diagram on the left is the diagram for a data recovery SBR, and a diagram on the right is the diagram for a clock recovery SBR.

The receiver according to the above-described embodiments may independently or separately control the first coefficient and the second coefficient in the CDR module. The receiver may allow the tap coefficient for data recovery to make h₁ 0 to reduce errors, and the tap coefficient for clock recovery to satisfy h₀ such that it may lock at the point where h₀ is the largest, through the independence of the SBR.

FIG. 5C is a diagram illustrating a PAM-3 signal sampling point, according to an embodiment of the present disclosure.

Referring to FIG. 5C, PAM-3 signal sampling uses two reference voltages VREFP and VREFN for data decoding and two reference voltages EREFP and EREFN for clock recovery.

In this case, EREFP and EREFN are values corresponding to h₀ and −h0 when expressed as cursors, respectively, and EREFP and EREFN may be obtained by an adaptation method of an SS-LMS (sign sign-least mean square) algorithm according to an embodiment. In addition, this process may use an error (ERR) comparator output according to an embodiment.

In addition, the tap coefficient for data recovery may also be obtained by the adaptation method of the SS-LMS algorithm that sends h₁ to 0 according to an embodiment. In addition, this process may use an output of the third adder and sampler 113 of FIG. 5A described above according to an embodiment.

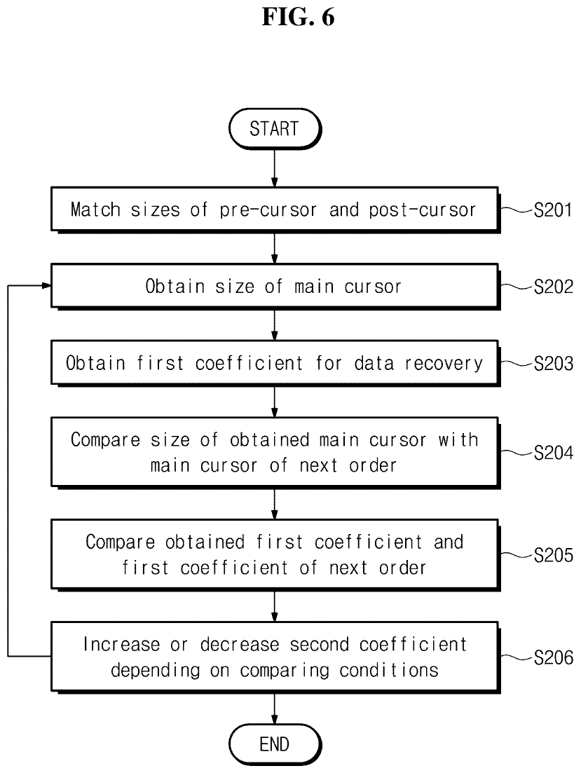

FIG. 6 is a flowchart illustrating an operation method of a receiver, according to an embodiment of the present disclosure.

Hereinafter, for convenience of description, the tap coefficient of the adder and samplers 111 and 112 for data recovery is defined as the first coefficient, and the tap coefficient of the adder and samplers 113 and 114 for clock recovery is defined as the second coefficient (refer to FIG. 5A).

Referring to FIG. 6, in the sampling process of the PAM-3 signal received through the communication channel, the operation method of the receiver for clock and data recovery may include operations S201 to S206.

First, in operation S201, the receiver may match the sizes of the pre-cursor and the post-cursor. For example, the receiver may lock the phase corresponding to the point where the sizes of the pre-cursor and the post-cursor match with the phase of the clock through the CDR module.

Subsequently, in operation S202, the size of the main cursor may be obtained.

In operation S203, the first coefficient for data recovery may be obtained.

In operation S204, the sizes of the obtained main cursor and the main cursor of the next order may be compared. For example, the receiver may compare the size of the current main cursor with the size of the next main cursor through the adaptation module to determine whether the current main cursor is located at the maximum value, which is the ideal position of the main cursor.

In operation S205, the first coefficient and the first coefficient of the next order may be compared.

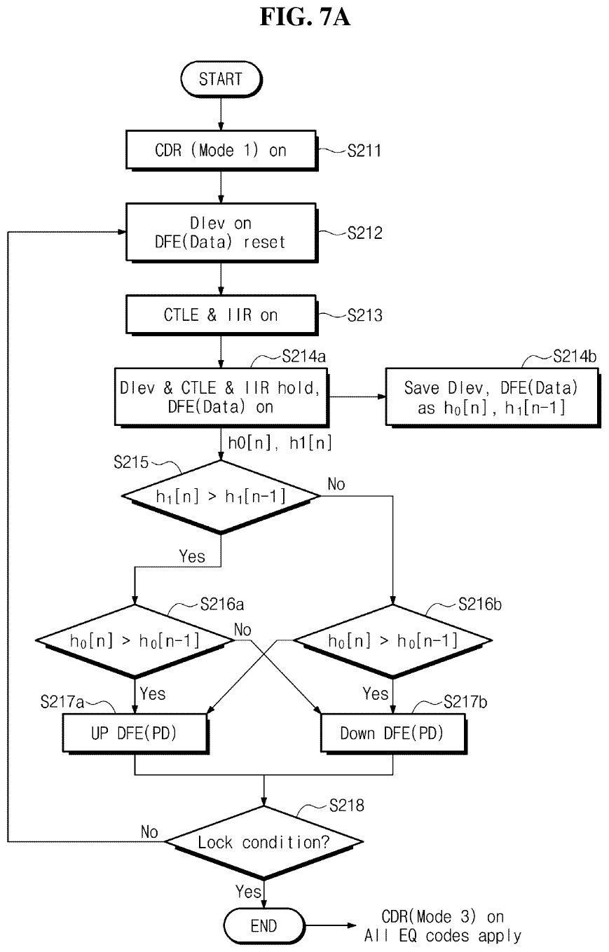

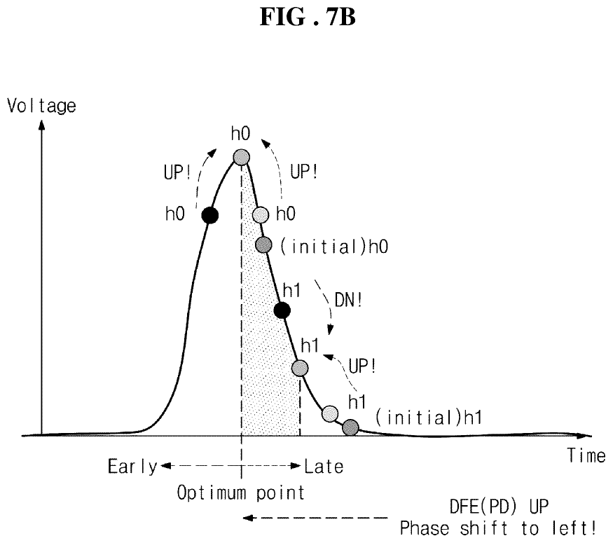

In operation S206, the second coefficient may be increased or decreased depending on conditions. Another embodiment of corresponding operation will be described later in FIG. 7A.

In addition, while repeating operations from S202 to S206, operation of returning to operation S202 of obtaining the size of the main cursor may be included. While repeating the process from S202 to S206, clock equalization and recovery may be performed.

FIG. 7A is a flowchart illustrating a method for determining a decision feedback equalizer tap coefficient, according to an embodiment of the present disclosure.

Referring to FIG. 7A, an algorithm for obtaining a tap coefficient for clock recovery may be confirmed. Since the update speed (loop bandwidth) of the baud rate CDR is set very fast, it may be described that the clock phase is always automatically locked at a point where h₁=h₋₁.

In addition, according to an embodiment of the present disclosure, operation S212 of finding a size of the main cursor, operation S214a of finding a first tap coefficient, operation S214b of storing the size of the main cursor as h₀[n−1] and storing the first tap coefficient as h₁[n−1] may be included.

Additionally, depending on the conditions, when h₁[n−1] is less than the current size h₁[n] and h₀[n−1] is less than the current coefficient h₀[n], operations S215, S216b, and S217a of increasing the second tap coefficient, when h₁[n−1] is less than the current size h₁[n] and h₀[n−1] is greater than the current coefficient h₀[n], operations S215, S216b, and S217b of decreasing the second tap coefficient, when h₁[n−1] is greater than the current size h₁[n] and h₀[n−1] is less than the current coefficient h₀[n], operations S215, S216a, and S217b of decreasing the second tap coefficient, and when h₁[n−1] is greater than the current size h₁[n] and h₀[n−1] is greater than the current coefficient h₀[n], operations S215, S216a, and S327a of increasing the second tap coefficient may be included after operations S214a and S214b.

In addition, operation of returning to operation of finding the sizes of the main cursor and the first post cursor may be included in order to continuously perform clock equalization and recovery.

In more detail, for the conditions, when the size of the obtained main cursor is less than the cursor value obtained in the next order and the size of the obtained first coefficient is less than the first coefficient value obtained in the next order, the second coefficient may be increased.

When the size of the obtained main cursor is less than the main cursor value in the next order and the size of the obtained first coefficient is greater than the first coefficient value in the next order, the second coefficient may be decreased.

Also, when the size of the obtained main cursor is greater than the main cursor value in the next order and the size of the obtained first coefficient is less than the first coefficient value in the next order, the second coefficient may be decreased.

Finally, when the size of the obtained main cursor is greater than the main cursor value in the next order and the size of the obtained first coefficient is greater than the first coefficient value in the next order, the second coefficient may be increased.

The above-described four cases may include a process of returning to operation of finding the sizes of the main cursor and the first post cursor in order to continuously perform clock equalization and recovery.

FIG. 7B is a diagram of SBR (single bit response) illustrating the process of FIG. 7A.

As described in the gray Initial h₀ of FIG. 7B, since the initial data is generally greater than the pre-cursor, the clock phase may be shifted to the right at the high point of the SBR.

Thereafter, according to the method of determining the tap coefficient of the decision feedback equalizer illustrated in FIG. 7A, h₀ and h₁ are repeatedly moved left and right along the SBR waveform, and the point where h₀ is the largest is locked, thereby preventing the occurrence of data errors.

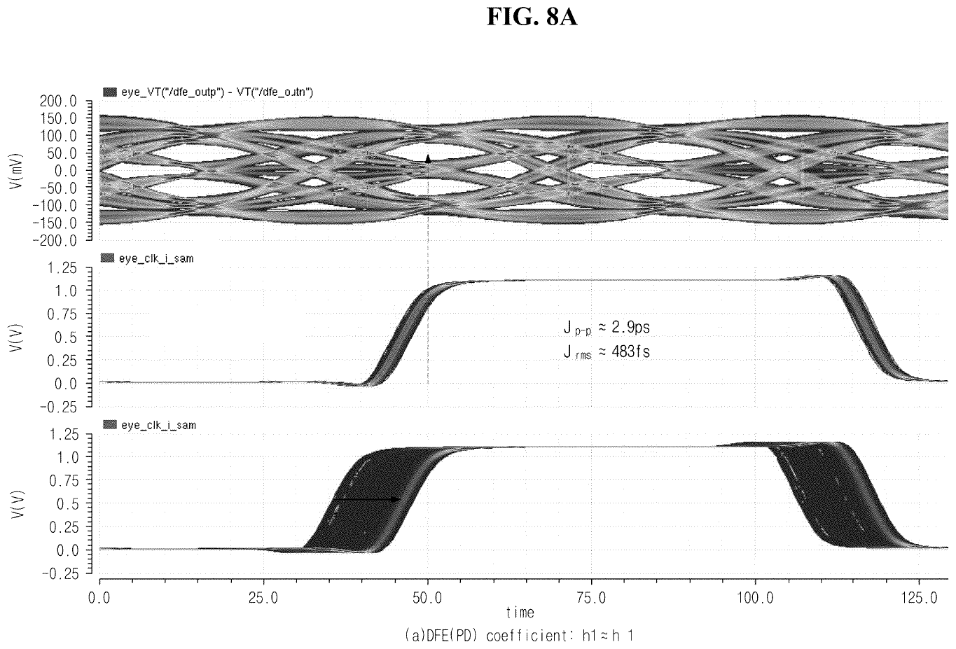

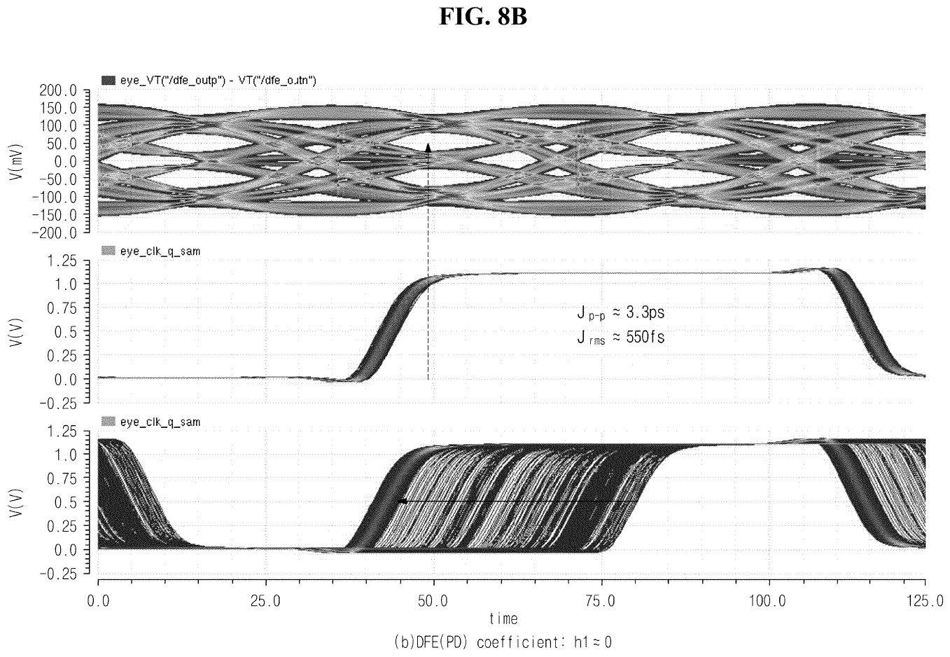

FIG. 8A and FIG. 8B is a diagram illustrating a change in a lock point of a CDR according to a tap coefficient for clock recovery, respectively.

In detail, the diagram of FIG. 8A is a diagram when the tap coefficient for clock recovery is appropriately applied, and the diagram of FIG. 8B is a diagram when a large tap coefficient is applied.

When a larger tap coefficient is used than when an appropriate tap coefficient is used, it may confirm the simulation in which the locking point is shifted further to the left.

In detail, the simulation according to an embodiment of the present disclosure may be confirmed that the size of the jitter is reduced by about 12 percent from 3.3 ps to 2.9 ps when the present disclosure is utilized.

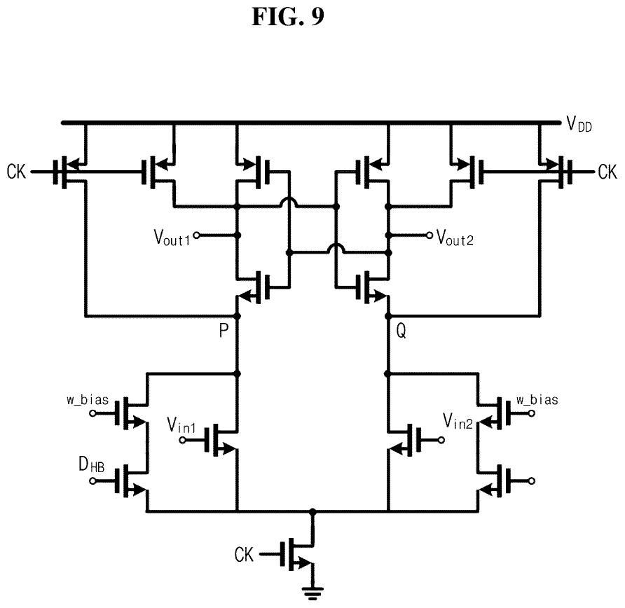

FIG. 9 is a diagram illustrating an adder and a sampler, according to an embodiment of the present disclosure.

The adder and sampler of FIG. 9 may be at least one of the adders and samplers 111 to 114 described in FIG. 5A described above.

Referring to FIG. 9, the tap coefficient may be determined by a process of changing a threshold voltage w_bias of a MOSFET by adjusting the voltage of the w_bias terminal of the adder and sampler. For example, when the input data is “0” or more and “1” is output, the threshold voltage of the adder and sampler may be described as “0”.

In a second circuit 111b, w_bias is used for summation, and an output voltage considering the weight (or the tap coefficient) is generated from input voltages Vᵢₙ₁ and Vᵢₙ₂ in the second circuit 111b, and is output in the form of Vₒᵤₜ₁ and Vₒᵤₜ₂ in a first circuit 111a. Here, w_bias may correspond to the first coefficient or the second coefficient described above.

Additionally, according to an embodiment, the threshold voltage of the adder and sampler may be controlled by the voltage increased or decreased from a 7-bit RDAC (resister digital analog converter).

The receiver according to an embodiment of the present disclosure may solve a problem of data error occurrence and a clock phase locking problem occurring during clock and data recovery by using a CDR (clock and data recovery) structure in which paths of taps for data recovery and taps for clock recovery are separated.

The above description refers to embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A receiver comprising:
a CDR (clock and data recovery) module configured to recover a clock and data from a PAM (pulse amplitude modulation)-3 signal received through a communication channel based on a first coefficient for equalizing and recovering the data and a second coefficient for equalizing and recovering the clock; and
an adaptation module configured to control the first coefficient and the second coefficient.

2. The receiver of claim 1, wherein the CDR module locks a phase of the clock to match a size of a pre-cursor and a size of a post-cursor, which are 1 UI (unit interval) apart from a main cursor for data recovery.

3. The receiver of claim 2, wherein the adaptation module is configured to:
obtain a size of the main cursor;
obtain the first coefficient; and
iterating increasing and decreasing the second coefficient in order by dividing conditions into comparing the size of the obtained main cursor with a size of a next order main cursor, and comparing the first coefficient with a next order first coefficient.

4. The receiver of claim 2, wherein the CDR module includes:
a decision feedback equalizer configured to perform equalization based on the first coefficient and the second coefficient;
a phase detector configured to perform a phase detection based on an equalizing signal corresponding to the equalization;
a loop filter configured to lock the phase of the clock based on a detection signal corresponding to the phase detection; and
an oscillator configured to output the clock having a phase corresponding to the locking.

5. The receiver of claim 3, wherein the conditions include:
a first case in which the second coefficient is increased when the size of the obtained main cursor is less than a main cursor value obtained in a next order and a size of the obtained first coefficient is less than a first coefficient value obtained in the next order;
a second case in which the second coefficient is decreased when the size of the obtained main cursor is less than the main cursor value obtained in the next order and the size of the obtained first coefficient is greater than the first coefficient value obtained in the next order;
a third case in which the second coefficient is decreased when the size of the obtained main cursor is greater than the main cursor value obtained in the next order and the size of the obtained first coefficient is less than the first coefficient value obtained in the next order; and
a fourth case in which the second coefficient is increased when the size of the obtained main cursor is greater than the main cursor value obtained in the next order and the size of the obtained first coefficient is greater than the first coefficient value obtained in the next order.

6. The receiver of claim 5, further comprising:
a decoder configured to decode the data.

7. The receiver of claim 5, further comprising:
an analog front end coupled to an input terminal of the CDR module to receive the PAM-3 signal so as to process on a digital domain.

8. A method of operating a receiver for recovering a clock and data, in a process of sampling a PAM-3 signal received through a communication channel, the method comprising:
matching sizes of a pre-cursor and a post-cursor;
obtaining a size of a main cursor;
obtaining a first coefficient for data recovery;
increasing and decreasing a second coefficient by dividing conditions into comparing the size of the obtained main cursor with a size of a next order main cursor, and comparing the first coefficient with a next order first coefficient; and
returning to the obtaining the size of the main cursor, to iterate the operations in order.

9. The method of claim 8, wherein the increasing and decreasing of the second coefficient by dividing the conditions includes:
increasing the second coefficient when the size of the obtained main cursor is less than a main cursor value obtained in a next order and a size of the obtained first coefficient is less than a first coefficient value obtained in the next order;
decreasing the second coefficient when the size of the obtained main cursor is less than the main cursor value obtained in the next order and the size of the obtained first coefficient is greater than the first coefficient value obtained in the next order;
decreasing the second coefficient when the size of the obtained main cursor is greater than the main cursor value obtained in the next order and the size of the obtained first coefficient is less than the first coefficient value obtained in the next order; and
increasing the second coefficient when the size of the obtained main cursor is greater than the main cursor value obtained in the next order and the size of the obtained first coefficient is greater than the first coefficient value obtained in the next order, and
wherein the operations are performed in parallel based on the conditions.
